(19) United States
(12) Patent Application Publication
(10) Pub. No.: US 2026/0331885 A1
(43) Pub. Date: Oct. 22, 2026

(54) WIRE SUPPORT MODULE AND BRACKET

(71) Applicant: SUMITOMO WIRING SYSTEMS, LTD., Yokkaichi-shi (JP)

(72) Inventors: Shizuka KIMURA, Yokkaichi-shi (JP); Yusuke SHIMIZU, Yokkaichi-shi (JP)

(21) Appl. No.: 19/642,666

(22) Filed: Apr. 9, 2026

(30) Foreign Application Priority Data
Apr. 17, 2025 (JP) 2025-068199

(51) Int. Cl. H02G 3/04; B60R 16/02; H02G 3/32

(52) U.S. Cl. CPC H02G 3/0406; B60R 16/0215; H02G 3/32

(57) ABSTRACT

Provided are a wire support module capable of preventing detachment of a protector from a bracket, and the bracket. A wire support module includes: a protector that accommodates at least part of a wire; and a bracket interposed between the protector and a vehicle body to attach the protector to the vehicle body. The protector includes, on a side surface of a protector body, a bracket fixing portion to which part of the bracket is fixed. The bracket includes a suppression portion that suppresses swinging of the protector about the bracket fixing portion as a fulcrum.

### TECHNICAL FIELD

The present disclosure relates to a wire support module and a bracket.

### BACKGROUND ART

Conventionally, a structure is well known in which a protector that accommodates a wire harness is attached to a vehicle body via a bracket, as disclosed in JP 2017-11810A. The protector described in JP 2017-11810A is provided with an attachment portion to which the bracket can be attached. The attachment portion has an insertion hole into which the bracket is insertable, and a plurality of locking pieces capable of engaging with a hole of the bracket are formed inside the insertion hole. The protector and the bracket are thus attached to each other by engaging the locking pieces provided on the attachment portion of the protector with the hole of the bracket.

JP 2017-11810A is an example of related art.

### SUMMARY OF THE INVENTION

Vehicles vibrate during operation of the engine and during traveling of the vehicle. Such vibrations affect the engagement between the locking pieces of the attachment portion of the protector and the hole of the bracket. This may result in detachment of the protector from the bracket. A measure to prevent detachment of the protector from the bracket is therefore required.

The present disclosure accordingly has an objective of providing a wire support module capable of preventing detachment of a protector from a bracket, and the bracket.

To solve the problem stated above, a wire support module includes: a protector that accommodates at least part of a wire; and a bracket interposed between the protector and a vehicle body to attach the protector to the vehicle body, wherein the protector includes, on a side surface of a protector body that accommodates the wire, a bracket fixing portion to which part of the bracket is fixed, and the bracket includes a suppression portion that suppresses swinging of the protector about the bracket fixing portion as a fulcrum.

According to the present disclosure, it is possible to prevent detachment of a protector from a bracket.

### BRIEF DESCRIPTION OF THE DRAWINGS

FIG. 1 is a perspective view of a wire support module according to one embodiment as seen from the back;

FIG. 2 is a perspective view of the wire support module as seen from the top;

FIG. 3 is an external view of the wire support module as seen from the axial direction of the wires;

FIG. 4 is a perspective view of a bracket;

FIG. 5 is an exploded perspective view of a protector and the bracket;

FIG. 6 is a perspective view of a bracket fixing portion of the protector;

FIG. 7 is a cross-sectional view taken along line VII-VII in FIG. 2;

FIG. 8 is an external view showing a state in which the wire support module is attached to a vehicle body; and

FIG. 9 is a view showing the operation of a suppression portion in the bracket.

### EMBODIMENTS OF THE INVENTION

First, embodiments of the present disclosure will be enumerated and described.
[1] A wire support module according to the present disclosure includes: a protector that accommodates at least part of a wire; and a bracket interposed between the protector and a vehicle body to attach the protector to the vehicle body, wherein the protector includes, on a side surface of a protector body that accommodates the wire, a bracket fixing portion to which part of the bracket is fixed, and the bracket includes a suppression portion that suppresses swinging of the protector about the bracket fixing portion as a fulcrum.

With this configuration, swinging of the protector about its bracket fixing portion to which the bracket is fixed as a fulcrum is suppressed by the suppression portion of the bracket. Hence, an unfixing load is less likely to be applied between the bracket and the bracket fixing portion. This makes it easier to maintain the fixed state between the protector and the bracket. Thus, detachment of the protector from the bracket can be prevented.
[2] In the above [1], the suppression portion has a support surface that contacts the protector to suppress swinging of the protector, and the support surface intersects with an attachment direction between the bracket fixing portion of the protector and the bracket. With this configuration, when the protector swings, the protector swinging in a rotation direction about the bracket fixing portion as a fulcrum can be surface-supported by the suppression portion of the bracket. It is therefore easy to maintain the fixed state between the bracket and the bracket fixing portion. The configuration is highly effective from this viewpoint as well.
[3] In the above [1] or [2], the suppression portion has a support surface that contacts the protector to suppress swinging of the protector, and the support surface is formed in an inclined surface shape to surface-support an inclined surface portion formed on the protector. With this configuration, even in the case where the shape of the protector includes the inclined surface portion, when the protector swings, the inclined surface portion can be surface-supported by the suppression portion having the inclined support surface. Accordingly, even in the case where the protector includes the inclined surface portion, swinging of the protector is effectively suppressed by surface support by the suppression portion, so that detachment of the protector from the bracket can be prevented.
[4] In any one of the above [1] to [3], a gap is provided between the suppression portion and the protector in a normal state, and the suppression portion contacts the protector when the protector swings due to an external load. With this configuration, when the protector is not swinging or is swinging only slightly, the protector does not contact the suppression portion of the bracket. Therefore, the suppression portion is enabled to function only when the protector swings significantly. Since it is not necessary to constantly use the suppression portion, this configuration is advantageous in terms of long-term use and improvement in durability of the suppression portion.
[5] In any one of the above [1] to [4], a fixing structure between the bracket and the bracket fixing portion is a structure in which a protrusion formed on one of the bracket and the bracket fixing portion and a recess formed in the other of the bracket and the bracket fixing portion engage with each other by elastic deformation and subsequent restoration. With this configuration, the protector can be fixed to the bracket by a simple attachment operation in which the protrusion is engaged with the recess. Even if a fixing structure that allows such a simple attachment operation is used, detachment of the protector from the bracket can be prevented.
[6] In any one of the above [1] to [5], the protector is attached to the vehicle body not only by the bracket but also by another bracket different from the bracket. With this configuration, the protector can be fixed to the vehicle body at a plurality of locations, so that detachment of the protector from the vehicle body can be prevented.
[7] A bracket according to the present disclosure is a bracket that is interposed between a protector and a vehicle body to attach the protector to the vehicle body, the protector accommodating at least part of a wire, the bracket including: an engaging piece that engages with a bracket fixing portion provided on a side surface of a protector body that accommodates the wire in the protector; and a suppression portion that suppresses swinging of the protector about the bracket fixing portion as a fulcrum. With this configuration, the same effects as in the above [1] can be achieved.

### Details of Embodiments of the Present Disclosure

Specific examples of the present disclosure will be described below with reference to the drawings. The present disclosure is not limited to these examples, but is defined by the claims and intended to include all modifications within the meaning and scope equivalent to the claims. In each drawing, some parts of the configurations may be exaggerated or simplified for the sake of explanation. In addition, the dimensional ratios of parts may differ from actual ones.

### Wire Support Module 1

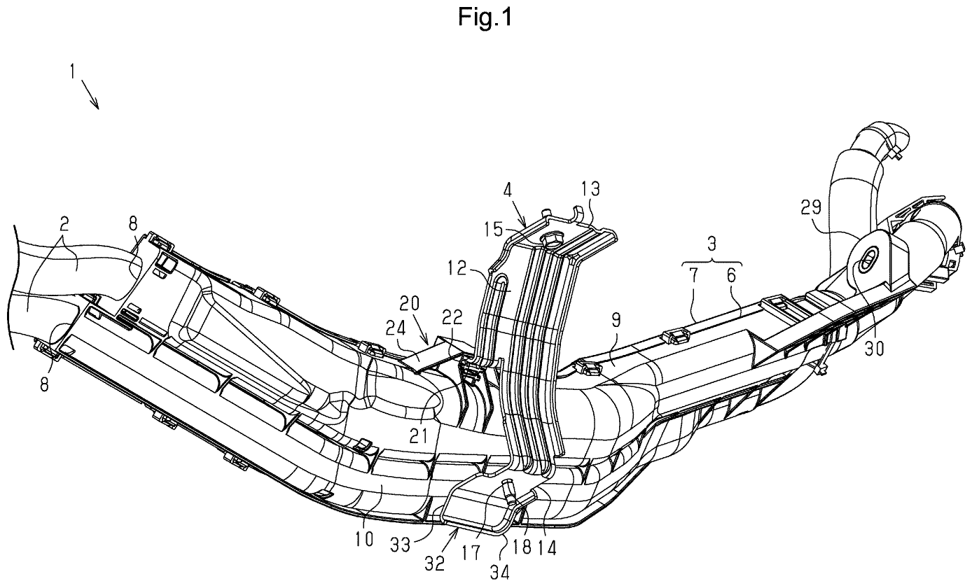

As shown in FIG. 1, a wire support module 1 includes a protector 3 that accommodates at least part of wires 2, and a bracket 4 for attaching the protector 3 to a vehicle body (not shown). The protector 3 is attached and fixed to the vehicle body via the bracket 4 in order to set the wire routing path. The bracket 4 is interposed between the protector 3 and the vehicle body. The bracket 4 is located on one of the pair of side surfaces of the protector 3.

A plurality of wires 2 are accommodated in the protector 3. Each wire 2 is, for example, a general wire including a core wire and an insulating coating that covers the core wire. The wire 2 may be, for example, a bare conductor, a shielded wire, an enameled wire, a nichrome wire, or an optical fiber. The wire 2 may be, for example, a signal wire or a power wire. The wire 2 may be a single linear object or a composite of a plurality of linear objects (such as a twisted wire).

### Protector 3

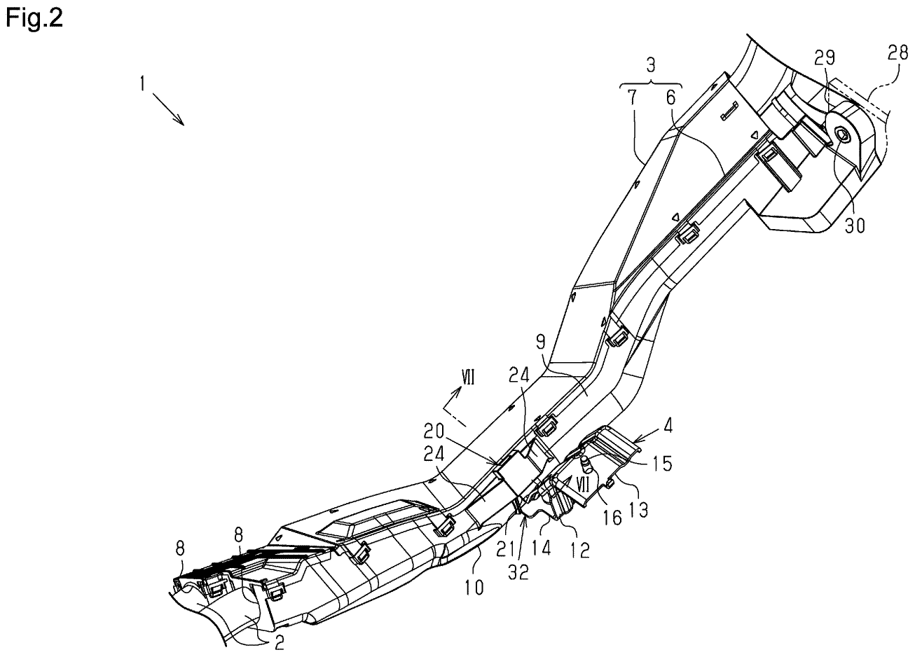

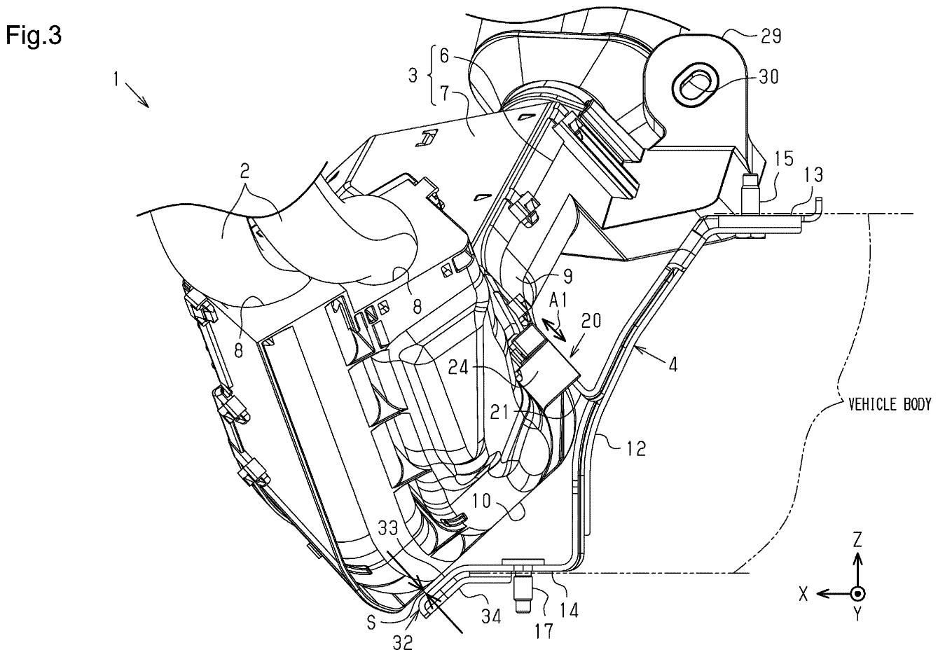

As shown in FIGS. 2 and 3, the protector 3 includes a protector body 6 that supports the accommodated wires 2, and a cover 7 that closes an opening of the protector body 6. The protector 3 has a substantially U shape in a side view, and is formed in a shape twisted in a rotation direction when seen from the axial direction. The wires 2 are accommodated in an accommodating portion 8 formed in the protector body 6 of the protector 3. The protector body 6 and the cover 7 are integrally assembled by a known locking structure in which an elastically deformable locking claw formed on one of the protector body 6 and the cover 7 engages with a recess formed on the other of the protector body 6 and the cover 7.

As shown in FIG. 3, the side surface of the protector 3 that faces the vehicle body when the protector 3 is attached to the vehicle body is formed in a shape in which two inclined surfaces that differ in inclination direction are arranged in the vertical direction. Specifically, the side surface of the protector 3 includes an inclined side surface portion 9 located on the upper side in the vertical direction (Z-axis direction in FIG. 3), and an inclined surface portion 10 located on the lower side in the vertical direction (Z-axis direction in FIG. 3). The side surface portion 9 is formed in a shape that descends in a direction approaching the vehicle body from a position away from the vehicle body. The inclined surface portion 10 is formed in a shape that ascends in a direction approaching the vehicle body from a position away from the vehicle body.

### Bracket 4

As shown in FIGS. 3 to 5, the bracket 4 includes a long base portion 12 as a main body part, a first fixing piece 13 provided at one longitudinal end of the base portion 12, and a second fixing piece 14 provided at the other longitudinal end of the base portion 12. The bracket 4 is made of metal. The first fixing piece 13 and the second fixing piece 14 are formed by bending the ends of the base material of the bracket 4 in opposite directions. The first fixing piece 13 is located at the upper end of the base portion 12. The second fixing piece 14 is located at the lower end of the base portion 12.

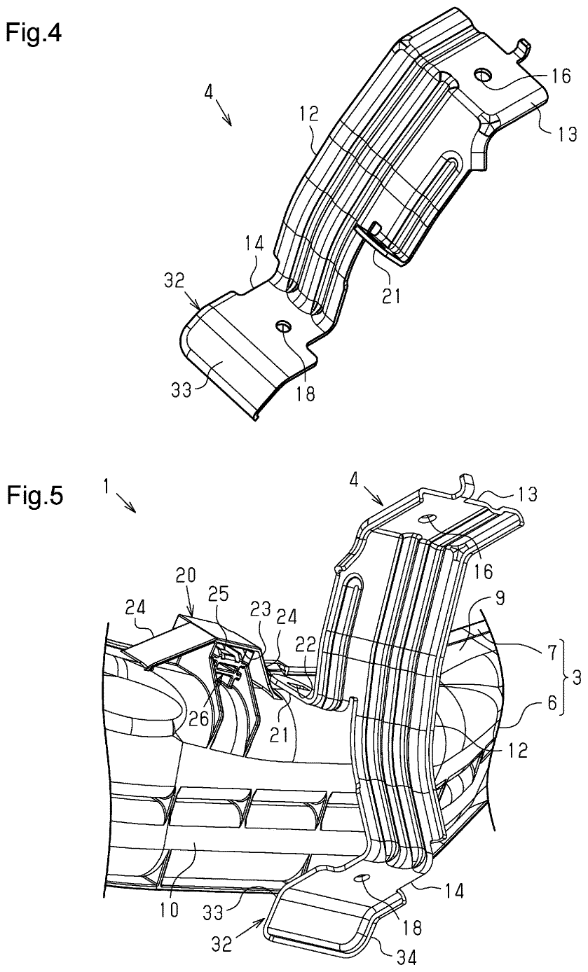

As shown in FIGS. 4 and 5, the first fixing piece 13 of the bracket 4 has a first hole 16 through which a first fastening portion 15 for fixing the bracket 4 to the vehicle body is inserted. The second fixing piece 14 of the bracket 4 has a second hole 18 through which a second fastening portion 17 for fixing the bracket 4 to the vehicle body is inserted. As shown in FIG. 3, the first fixing piece 13 of the bracket 4 is fixed to the vehicle body by the first fastening portion 15, and the second fixing piece 14 of the bracket 4 is fixed to the vehicle body by the second fastening portion 17. Thus, the bracket 4 in this example is fixed to the vehicle body at two points: the first fastening portion 15 and the second fastening portion 17. The first fastening portion 15 and the second fastening portion 17 are, for example, bolts.

### Attachment Structure of Protector 3 and Bracket 4

As shown in FIGS. 1 to 3, the protector 3 includes a bracket fixing portion 20 to which part of the bracket 4 is fixed. The bracket fixing portion 20 is located on one side surface facing the vehicle body (the side surface portion 9 in this example) out of the pair of side surfaces of the protector body 6 that accommodates the wires 2. Thus, the bracket 4 in this example is not fixed to the vehicle body on both side surfaces but is fixed to the vehicle body by support on only one side surface, namely, cantilever support.

As shown in FIGS. 4 and 5, the bracket 4 includes an engaging piece 21 that engages with the bracket fixing portion 20 provided on the side surface of the protector body 6. The engaging piece 21 is located at a longitudinally intermediate position on the base portion 12. The engaging piece 21 is formed by bending part of the base material of the bracket 4. The engaging piece 21 has a recess 22 used for fixing to the bracket fixing portion 20. The recess 22 is a through hole.

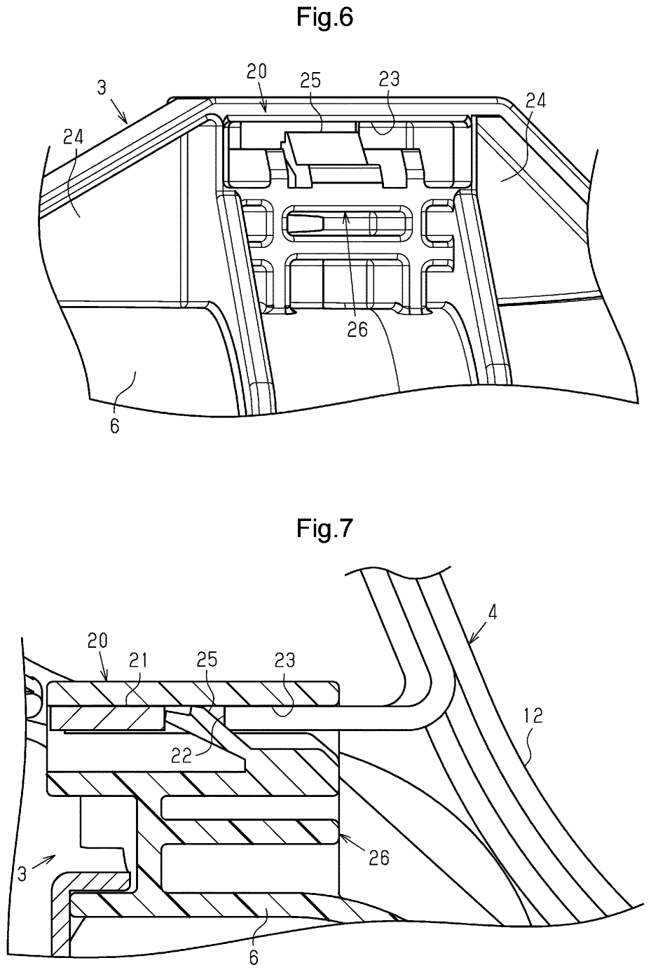

As shown in FIGS. 5 and 6, the bracket fixing portion 20 has an opening 23 for inserting the engaging piece 21 of the bracket 4. The bracket fixing portion 20 has a pair of reinforcing walls 24 formed on both sides of the opening 23 for reinforcement of the bracket fixing portion 20. As shown in FIG. 6, an elastically deformable protrusion 25 that engages with the engaging piece 21 of the bracket 4 is formed inside the opening 23 of the bracket fixing portion 20. The base end of the protrusion 25 is supported by a seat portion 26 on which lattice-shaped reinforcing ribs are formed.

As shown in FIG. 7, when the engaging piece 21 of the bracket 4 is inserted into the opening 23 of the bracket fixing portion 20, the protrusion 25 of the bracket fixing portion 20 engages with the recess 22 of the engaging piece 21 during the insertion process. When the protrusion 25 of the bracket fixing portion 20 engages with the recess 22 of the bracket 4, they transition to a locked state. Thus, the fixing structure between the bracket 4 and the bracket fixing portion 20 is such that the protrusion 25 formed on one of them and the recess 22 formed in the other engage with each other by elastic deformation and subsequent restoration.

### Fixation of Protector 3 to Vehicle Body

As shown in FIGS. 1 to 3, the protector 3 includes a bracket attachment piece 29 for attaching another bracket 28 (shown in FIG. 2). The bracket attachment piece 29 is located, for example, at one longitudinal end (upper end in this example) of the protector body 6 and has a hole 30 for inserting a bolt, a screw, or the like. The bracket attachment piece 29 is fixed to the vehicle body via the other bracket 28 that is fixed by a bolt, a screw, or the like inserted through the hole 30. As described above, the protector 3 in this example is attached to the vehicle body not only by the bracket 4 but also by the other bracket 28. The protector 3 in this example is thus fixed to the vehicle body at two points: the bracket 4 and the other bracket 28.

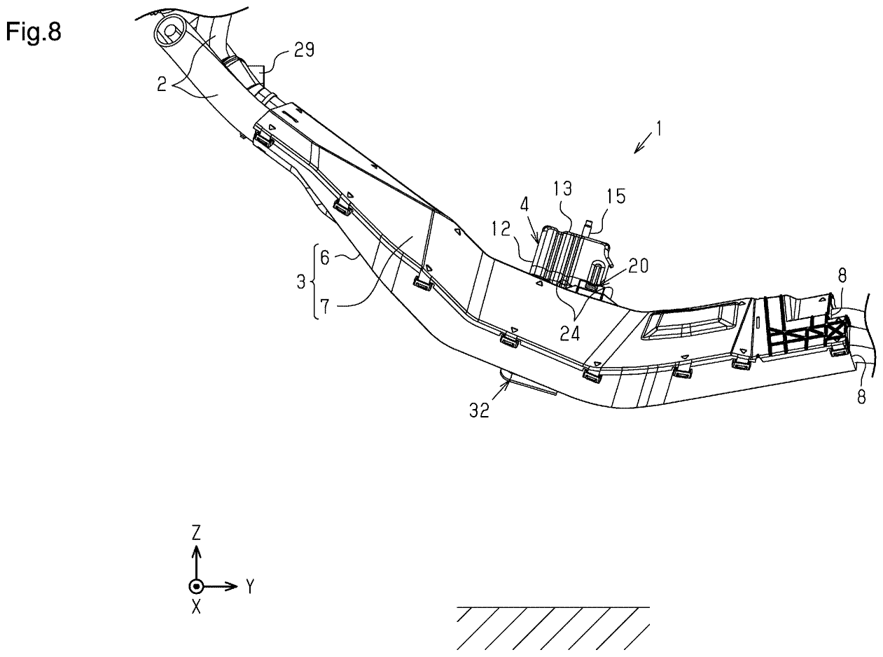

As shown in FIG. 8, the protector 3 is arranged in a state in which one axial end is located higher than the other axial end relative to a horizontal plane. In this example, the protector 3 is arranged with its left-side end located higher than its right-side end in the drawing. Moreover, the bracket 4 is attached to the vehicle body in a state of being inclined by a predetermined amount relative to the vertical direction (up-down direction in the drawing) in a side view.

### Suppression of Swinging of Protector 3

As shown in FIGS. 3 to 5, the bracket 4 includes a suppression portion 32 that suppresses swinging of the protector 3 about the bracket fixing portion 20 as a fulcrum. The suppression portion 32 has a support surface 33 that contacts the protector 3 to suppress swinging of the protector 3. The support surface 33 intersects with the attachment direction between the bracket fixing portion 20 of the protector 3 and the bracket 4 (the direction of arrow A1 in FIG. 3). The support surface 33 is also inclined relative to the vertical direction (Z-axis direction in FIG. 3). Thus, the support surface 33 is formed in an inclined surface shape in order to surface-support the inclined surface portion 10 formed on the protector 3.

A reinforcing rib 34 is formed on the back surface of the suppression portion 32. The rib 34 is formed along the edge of the back surface of the plate-shaped suppression portion 32. The rib 34 is formed in a shape in which part of the edge of the plate-shaped suppression portion 32 protrudes toward the back surface.

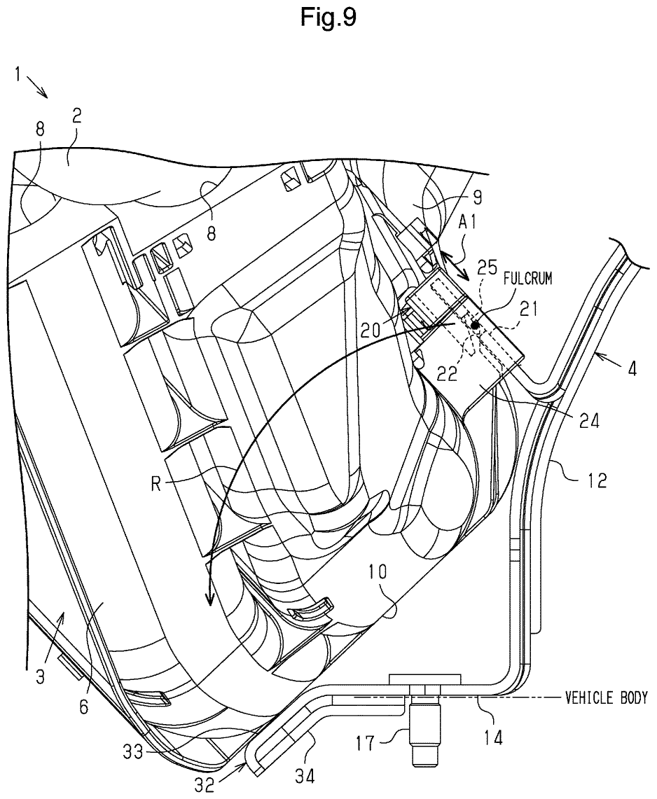

As shown in FIG. 9, swinging of the protector 3 is a movement in a rotation direction (the direction of arrow R in FIG. 9) about the bracket fixing portion 20 when the protector 3 is seen from the longitudinal direction (the depth direction of the drawing in FIG. 9). In a normal state, there is a gap S between the suppression portion 32 and the protector 3. The suppression portion 32 contacts the protector 3 when the protector 3 swings due to an external load.

### Functions of the Embodiment

Next, the functions of the wire support module 1 and the bracket 4 according to this embodiment will be described.

As shown in FIG. 9, for example, when the vehicle body vibrates during operation of the engine or during traveling of the vehicle, the protector 3 may swing in the rotation direction (the direction of arrow R in FIG. 9) about the bracket fixing portion 20 as a fulcrum. In the case of cantilever support in which the protector 3 is supported by the vehicle body on only one of the pair of side surfaces as in this example, if a large vibration load is applied to the protector 3 due to vibration, the protrusion 25 of the protector 3 may disengage from the recess 22 of the bracket 4, causing the protector 3 to roll in the rotation direction.

In this example, the bracket 4 includes the suppression portion 32 for restricting swinging of the protector 3 in the rotation direction. Therefore, even if the protector 3 swings in the rotation direction, the inclined surface portion 10 on the back surface of the protector body 6 contacts the suppression portion 32 of the bracket 4, so that swinging of the protector 3 is restricted. This makes it easier to maintain the engagement between the protrusion 25 of the protector 3 and the recess 22 of the bracket 4. Thus, the protector 3 can be prevented from being detached from the bracket 4.

When the protector 3 swings, the part where the bracket 4 and the bracket fixing portion 20 are fixed to each other is subjected to a load in the release direction (the direction of arrow R in FIG. 9). In this example, the support surface 33 of the suppression portion 32 intersects with the attachment direction between the protector 3 and the bracket 4 (the direction of arrow A1 in FIG. 9). Accordingly, the protector 3 trying to move in a direction in which fixation between the bracket 4 and the bracket fixing portion 20 is released can be surface-supported by the support surface 33 of the suppression portion 32 of the bracket 4. This makes it easier to maintain the fixation between the bracket 4 and the bracket fixing portion 20, further contributing to preventing detachment of the protector 3.

### Effects of the Embodiment

The wire support module 1 and the bracket 4 according to the above-described embodiment have the following effects.
(1) In the wire support module 1, the protector 3 that accommodates the wire 2 is fixed to the vehicle body via the bracket 4. The protector 3 includes, on a side surface of the protector body 6, the bracket fixing portion 20 to which part of the bracket 4 is fixed. The bracket 4 includes the suppression portion 32 that suppresses swinging of the protector 3 about the bracket fixing portion 20 as a fulcrum.

With this configuration, swinging of the protector 3 about its bracket fixing portion 20 to which the bracket 4 is fixed as a fulcrum is suppressed by the suppression portion 32 of the bracket 4. Hence, an unfixing load is less likely to be applied between the bracket 4 and the bracket fixing portion 20. This makes it easier to maintain the fixed state between the protector 3 and the bracket 4. Thus, detachment of the protector 3 from the bracket 4 can be prevented.
(2) The suppression portion 32 has the support surface 33 that contacts the protector 3 to suppress swinging of the protector 3. The support surface 33 intersects with the attachment direction between the bracket fixing portion 20 of the protector 3 and the bracket 4 (the direction of arrow A1 in FIG. 3 or 9). With this configuration, when the protector 3 swings, the protector 3 swinging in the rotation direction about the bracket fixing portion 20 as a fulcrum can be surface-supported by the suppression portion 32 of the bracket 4. It is therefore easy to maintain the fixed state between the bracket 4 and the bracket fixing portion 20. The configuration is highly effective from this viewpoint as well.
(3) The support surface 33 is formed in an inclined surface shape to surface-support the inclined surface portion 10 formed on the protector 3. With this configuration, even in the case where the shape of the protector 3 includes the inclined surface portion 10, when the protector 3 swings, the inclined surface portion 10 can be surface-supported by the suppression portion 32 having the inclined support surface 33. Accordingly, even in the case where the protector 3 includes the inclined surface portion 10, swinging of the protector 3 is effectively suppressed by surface support by the suppression portion 32, so that detachment of the protector 3 from the bracket 4 can be prevented.
(4) The gap S is provided between the suppression portion 32 and the protector 3 in a normal state, and the suppression portion 32 contacts the protector 3 when the protector 3 swings due to an external load. With this configuration, when the protector 3 is not swinging or is swinging only slightly, the protector 3 does not contact the suppression portion 32 of the bracket 4. Therefore, the suppression portion 32 is enabled to function only when the protector 3 swings significantly. Since it is not necessary to constantly use the suppression portion 32, this configuration is advantageous in terms of long-term use and improvement in durability of the suppression portion 32.
(5) The fixing structure between the bracket 4 and the bracket fixing portion 20 is a structure in which the protrusion 25 formed on one of the bracket 4 and the bracket fixing portion 20 and the recess 22 formed in the other of the bracket 4 and the bracket fixing portion 20 engage with each other by elastic deformation and subsequent restoration. With this configuration, the protector 3 can be fixed to the bracket 4 by a simple attachment operation in which the protrusion 25 is engaged with the recess 22. Even if a fixing structure that allows such a simple attachment operation is used, detachment of the protector 3 from the bracket 4 can be prevented.
(6) The protector 3 is attached to the vehicle body not only by the bracket 4 but also by another bracket 28 different from the bracket 4. With this configuration, the protector 3 can be fixed to the vehicle body at a plurality of locations, so that detachment of the protector 3 from the vehicle body can be prevented.

### Other Embodiments

The following modifications can be made to the above-described embodiment. The above-described embodiment and the modifications described below may be combined unless they are technically inconsistent.

The shape of the protector 3 is not limited to a shape twisted around the wire axis, and may be modified to other shapes, such as a shape extending straight in the wire axial direction.

The number of wires accommodated in the protector 3 is not limited.

The bracket 4 is not limited to being fixed to the vehicle body at one point, and may be fixed to the vehicle body at a plurality of points.

The structure of the bracket 4 and the bracket fixing portion 20 may be modified, for example, such that the bracket 4 includes the protrusion 25 and the protector 3 (the bracket fixing portion 20) includes the recess 22 with which the protrusion 25 engages.

The structure of the bracket 4 and the bracket fixing portion 20 is not limited to a structure in which the protrusion 25 engages with the recess 22, and may be, for example, a structure using fastening members such as bolts or screws.

The suppression portion 32 is not limited to a substantially rectangular shape when seen from the front, and may be modified to other shapes, such as an inverted T shape.

The suppression portion 32 is not limited to supporting the bracket 4 with an inclined surface. For example, the suppression portion 32 may support the bracket 4 with a surface arranged in the horizontal direction or with a surface arranged in the vertical direction.

The suppression portion 32 may contact the bracket 4 even in a normal state.

The surface of the protector 3 supported by the suppression portion 32 is not limited to the inclined surface portion 10. For example, if the back surface of the protector 3 is formed as a flat surface in the horizontal direction, this flat surface may be supported by the suppression portion 32.

The position of the bracket attachment piece 29 to which the other bracket 28 is attached in the protector 3 is not limited to the upper end of the protector 3, and may be another position such as the lower end of the protector 3.

The rotation subjected to swing suppression is not limited to rotation in the direction of arrow R shown in FIG. 9. For example, the suppression portion 32 may be formed to suppress rotation about an axis extending in the direction of arrow A1 indicated as the attachment direction in FIG. 9.

The wire support module 1 (bracket 4) is not limited to being used in vehicles and may also be used in other products and devices.

While the present disclosure has been described by way of embodiments, the present disclosure is not limited to such embodiments or structures. The present disclosure encompasses various modifications and variations within the scope of equivalents. In addition, various combinations and forms, as well as other combinations and forms including only one element, more elements, or fewer elements thereof, are also within the scope and spirit of the present disclosure.

### LIST OF REFERENCE NUMERALS

1: Wire Support Module
2: Wire
3: Protector
4: Bracket
6: Protector Body
7: Cover
8: Accommodating Portion
9: Side Surface Portion
10: Inclined Surface Portion
12: Base Portion
13: First Fixing Piece
14: Second Fixing Piece
15: First Fastening Portion
16: First Hole
17: Second Fastening Portion
18: Second Hole
20: Bracket Fixing Portion
21: Engaging Piece
22: Recess
23: Opening
24: Reinforcing Wall
25: Protrusion
26: Seat Portion
28: Another Bracket
29: Bracket Attachment Piece
30: Hole
32: Suppression Portion
33: Support Surface
34: Rib
S: Gap

What is claimed is:

1. A wire support module comprising:
a protector that accommodates at least part of a wire; and
a bracket interposed between the protector and a vehicle body to attach the protector to the vehicle body,
wherein the protector includes, on a side surface of a protector body that accommodates the wire, a bracket fixing portion to which part of the bracket is fixed, and
the bracket includes a suppression portion that suppresses swinging of the protector about the bracket fixing portion as a fulcrum.

2. The wire support module according to claim 1, wherein the suppression portion has a support surface that contacts the protector to suppress swinging of the protector, and
the support surface intersects with an attachment direction between the bracket fixing portion of the protector and the bracket.

3. The wire support module according to claim 1, wherein the suppression portion has a support surface that contacts the protector to suppress swinging of the protector, and
the support surface is formed in an inclined surface shape to surface-support an inclined surface portion formed on the protector.

4. The wire support module according to claim 1, wherein a gap is provided between the suppression portion and the protector in a normal state, and the suppression portion contacts the protector when the protector swings due to an external load.

5. The wire support module according to claim 1, wherein a fixing structure between the bracket and the bracket fixing portion is a structure in which a protrusion formed on one of the bracket and the bracket fixing portion and a recess formed in the other of the bracket and the bracket fixing portion engage with each other by elastic deformation and subsequent restoration.

6. The wire support module according to claim 1, wherein the protector is attached to the vehicle body not only by the bracket but also by another bracket different from the bracket.

7. A bracket that is interposed between a protector and a vehicle body to attach the protector to the vehicle body, the protector accommodating at least part of a wire, the bracket comprising:
an engaging piece that engages with a bracket fixing portion provided on a side surface of a protector body that accommodates the wire in the protector; and
a suppression portion that suppresses swinging of the protector about the bracket fixing portion as a fulcrum.
